(19) United States
(12) Patent Application Publication
(10) Pub. No.: US 2025/0237397 A1
(43) Pub. Date: Jul. 24, 2025

(54) OUTSIDE AIR PURIFICATION SYSTEM FOR A VEHICLE AND A METHOD OF CONTROLLING THE SAME

(71) Applicants: HYUNDAI MOTOR COMPANY, Seoul (KR); KIA CORPORATION, Seoul (KR)

(72) Inventor: Nam-Seok Yun, Hwaseong-si (KR)

(73) Assignees: HYUNDAI MOTOR COMPANY, Seoul (KR); KIA CORPORATION, Seoul (KR)

(21) Appl. No.: 18/941,710

(22) Filed: Nov. 8, 2024

(30) Foreign Application Priority Data
Jan. 22, 2024 (KR) 10-2024-0009572

(51) Int. Cl. F24F 8/192; B03C 3/011; B03C 3/08; B03C 3/12; B03C 3/41

(52) U.S. Cl. CPC F24F 8/192; B03C 3/011; B03C 3/08; B03C 3/12; B03C 3/41

(57) ABSTRACT

An outside air purification system for a vehicle includes a cooling fan installed on a roof of a vehicle, a duct for guiding air to the cooling fan, and a dust collection unit for adsorbing pollutants contained in the air flowing through the duct, which collects and adsorbs pollutants contained in the air while the vehicle travels on the road, thereby purifying outside air of the vehicle.

### CROSS-REFERENCE TO RELATED APPLICATION

This application claims priority to Korean Patent Application No. 10-2024-0009572, filed on Jan. 22, 2024, the entire contents of which are incorporated herein by reference.

### BACKGROUND

### Field

The present disclosure relates to an outside air purification system for a vehicle, which may be mounted on the vehicle to purify outside air of the vehicle, and a method of controlling the same.

### Description of Related Art

Conventional internal combustion engine vehicles emit pollutants into the air due to combustion of fuel in internal combustion engines mounted on the vehicles.

Recently, due to gradually tightening exhaust gas regulations and the electrification of vehicles, air pollution due to exhaust gases is decreasing.

However, as the vehicles are driven, dust is generated due to wear of tires or brake pads, which is increasingly becoming a topic of interest as a cause of air pollution.

In addition, air pollution is occurring due to seasonal factors such as yellow dust and emission of fumes from factory operations.

To decrease air pollution, some countries construct buildings for air purification in areas with severe air pollution to purify the polluted air in cities. However, although air purification buildings may purify air in areas close to the building, it is difficult to expect sufficient air purification performance in areas far from the building. In addition, in areas close to the building, noise is generated due to an operation, much power is consumed for air purification, and construction costs are enormous.

As described above, since it is difficult to purify outside air, people had no choice but to respond to such a situation in a method of refraining from outdoor activities or wearing masks on days with severe fine dust.

The statements in this section merely provide background information related to the present disclosure and may not constitute prior art.

### SUMMARY

The present disclosure has been invented to solve the problems and is directed to providing an outside air purification system for a vehicle, which is mounted outside the vehicle to purify outside air, and a method of controlling the same.

In an embodiment of the present disclosure, an outside air purification system for a vehicle includes a cooling fan installed on a roof of the vehicle, a duct configured to guide air to the cooling fan, and a dust collection unit installed inside the duct and configured to adsorb pollutants contained in the air flowing through the duct.

The dust collection unit may include an ionization line installed at an inlet of the dust collection unit and configured to generate a high voltage when power is applied to the dust collection unit, and a plurality of electrode plates installed behind the ionization line and disposed parallel to each other. The plurality of electrode plates is configured to be charged when the power is applied to the dust collection unit.

The pollutants contained in the air flowing into the dust collection unit may be charged while passing through the ionization line and adsorbed to the plurality of electrode plates while passing through the plurality of electrode plates.

A pre-filter configured to collect the pollutants contained in the air flowing into the duct may be further installed in front of the dust collection unit in the duct.

The duct may include an air duct configured to guide the air from an inlet installed on the roof to the duct, and a water duct branched from the air duct to drain moisture flowing into the inlet.

A water filter configured to filter the pollutants contained in the moisture passing through the dust collection unit may be installed on the water duct.

The outside air purification system may further include a control unit configured to receive a dust concentration from a dust concentration sensor installed on the vehicle and control an operation of the dust collection unit and the cooling fan.

The control unit may be configured to operate the cooling fan when a vehicle speed of the vehicle is smaller than or equal to a reference vehicle speed previously set to operate the cooling fan.

The outside air purification system may further include a rain sensor configured to detect raindrops outside the vehicle, and a resistance sensor configured to detect an insulation resistance of the dust collection unit inside the dust collection unit. In particular, output values of the rain sensor and the resistance sensor may be input to the control unit.

The control unit may be configured to determine that it is raining when raindrops are detected by the rain sensor or when the insulation resistance inside the dust collection unit measured by the resistance sensor is smaller than or equal to a preset reference resistance to stop the operation of the dust collection unit.

The cooling fan may be configured to cool a battery installed on the roof.

In another embodiment of the present disclosure, a method of controlling an outside air purification system for a vehicle includes: a dust concentration comparing operation in which a control unit determines whether a dust concentration of outside air is greater than or equal to a reference concentration previously set to operate a dust collection unit, and a dust collection unit operation in which the control unit applies power to the dust collection unit so that the dust collection unit operates.

The method may further include a vehicle speed comparing operation in which, before the dust collection unit operation is performed, the control unit compares a vehicle speed of the vehicle with a reference speed previously set to operate a cooling fan, and a cooling fan operation in which the control unit operates the cooling fan mounted for cooling a battery when the vehicle speed is less than or equal to the reference speed.

When the vehicle speed exceeds the reference speed in the vehicle speed comparing operation, the dust collection unit operation may be performed.

The method may further include a rain determining operation in which the control unit determines that it is raining between the dust concentration comparing operation and the vehicle speed comparing operation. When it is determined that it is not raining in the rain determining operation, the vehicle speed comparing operation may be performed.

The rain determining operation may include an insulation resistance comparing operation in which the control unit compares an insulation resistance inside the dust collection unit with a reference resistance previously set to operate the dust collection unit, and a raindrop detection determining operation in which the control unit determines whether a raindrop detection signal is input to the control unit from a rain sensor.

The control unit may determine that it is raining when the insulation resistance is smaller than or equal to the reference resistance or the raindrop detection signal is input from the rain sensor.

When it is determined that it is raining in the rain determining operation, the process may return to the dust concentration comparing operation (i.e., reperforming the dust concentration comparing operation).

When the vehicle travels and a predetermined amount of air flows into the dust collection unit due to traveling wind, the control unit does not operate the cooling fan.

The outside air purification system may further include a heat exchanger in front of the cooling fan for dissipating heat while coolant cooling a battery circulates in the system.

According to the outside air purification system for a vehicle having the above configuration, and the method of controlling the same according to the present disclosure, by collecting and adsorbing pollutants contained in the air using a vehicle which travels on the road, it is possible to purify air.

In particular, by purifying air using the vehicles which are distributed in a certain area to travel, it is possible to purify the air uniformly without the air purification effect being concentrated on a particular area.

In addition, by supplying the sufficient amount of air to the dust collection unit by the traveling wind of the traveling vehicle and supplying air by operating only the cooling fan when the vehicle stops or travels slowly, it is possible to save the energy required for air purification.

In addition, since the pollutants contained in the air may be removed after being collected through the water filter, the phenomenon in which the pollutants re-pollute the air does not occur.

### BRIEF DESCRIPTION OF THE DRAWINGS

FIG. 1 is a perspective view showing a vehicle to which an outside air purification system for a vehicle according to the present disclosure is applied.

FIG. 2 is a cross-sectional view along line I-I in FIG. 1.

FIG. 3 is a schematic view showing a dust collection unit applied to the outside air purification system for a vehicle according to an embodiment of the present disclosure.

FIG. 4 is a perspective view showing the dust collection unit applied to the outside air purification system for a vehicle according to an embodiment of the present disclosure.

FIG. 5 is a schematic view showing an operation state of the outside air purification system during a vehicle is traveling according to an embodiment of the present disclosure.

FIG. 6 is a schematic view showing an operation state of the outside air purification system during a vehicle is stopping according to an embodiment of the present disclosure.

FIG. 7 is a schematic view showing an operation state of the outside air purification system for a vehicle during rainy condition according to an embodiment of the present disclosure.

FIG. 8 is a flowchart illustrating a method of controlling the outside air purification system for a vehicle according to an embodiment of the present disclosure.

The drawings described herein are for illustration purposes only and are not intended to limit the scope of the present disclosure in any way.

### DETAILED DESCRIPTION

Hereinafter, an outside air purification system for a vehicle and a method of controlling the same according to the present disclosure are described in detail with reference to the accompanying drawings.

The following description is merely exemplary in nature and is not intended to limit the present disclosure, application, or uses. It should be understood that throughout the drawings, corresponding reference numerals indicate like or corresponding parts and features.

When a component, device, element, or the like of the present disclosure is described as having a purpose or performing an operation, function, or the like, the component, device, or element should be considered herein as being “configured to” meet that purpose or to perform that operation or function.

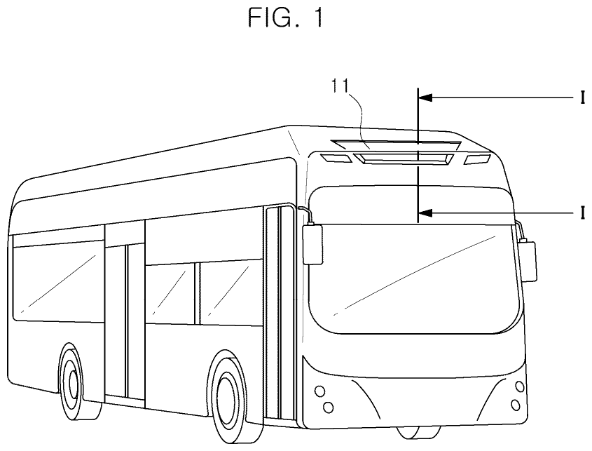

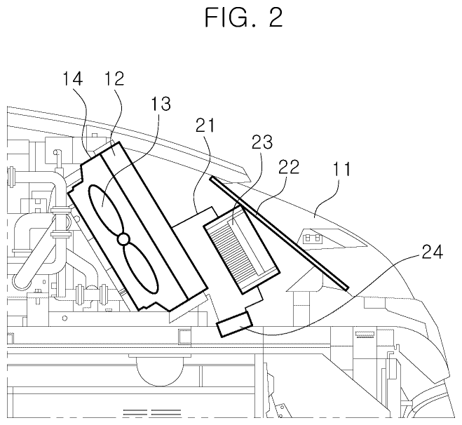

According to an embodiment of the present disclosure, with reference to FIGS. 1-2, the outside air purification system for a vehicle may include a cooling fan 13 installed on a roof of a vehicle 1, a duct 21 for guiding air to the cooling fan 13, and a dust collection unit 23 installed inside the duct 21 to adsorb pollutants contained in the air flowing through the duct 21.

The cooling fan 13, a heat exchanger 12, and the like for cooling may be installed on the roof of the vehicle to cool a device mounted on the vehicle 1.

For example, when the vehicle 1 is an electric bus, the heat exchanger 12 may be a radiator for dissipating heat while coolant cooling a battery circulates, and the cooling fan 13 may allow air to flow into the radiator to promote the heat dissipation of the coolant to ultimately allow the battery to be cooled.

In addition, the heat exchanger 12 may be a condenser for dissipating heat as refrigerant of an air conditioning system circulates, and the cooling fan 13 may allow air to flow into the condenser to promote the heat dissipation of the refrigerant.

The cooling fan 13 may be installed inside a shroud 14 to generate air flow when air flow is required.

The duct 21 may be installed on the roof of the vehicle 1 to guide air to the cooling fan 13. An inlet of the duct 21 may be connected to an inlet 11 installed on the roof of the vehicle, and when the vehicle 1 is in motion, traveling wind may flow into the cooling fan 13 through the duct 21.

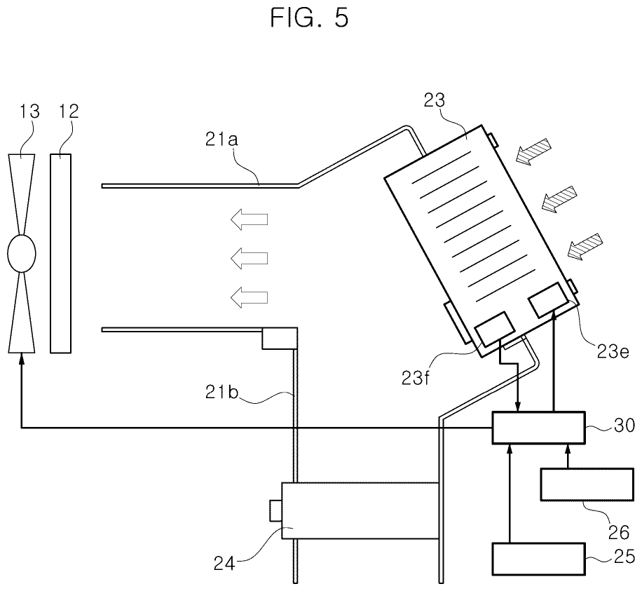

In one embodiment of the present disclosure, with reference to FIG. 5, the duct 21 may include an air duct 21a for guiding air to the cooling fan 13, and a water duct 21b branched from the air duct 21a to drain moisture flowing into the duct 21.

The air duct 21a may guide air from the inlet 11 to the cooling fan 13.

The water duct 21b may be branched from the air duct 21a to drain moisture flowing into the inlet 11 to the outside.

The dust collection unit 23 may be installed inside the duct 21, (more specifically, inside the air duct 21a) to adsorb and purify pollutants, such as particulate (PM), contained in the air flowing through the air duct 21a.

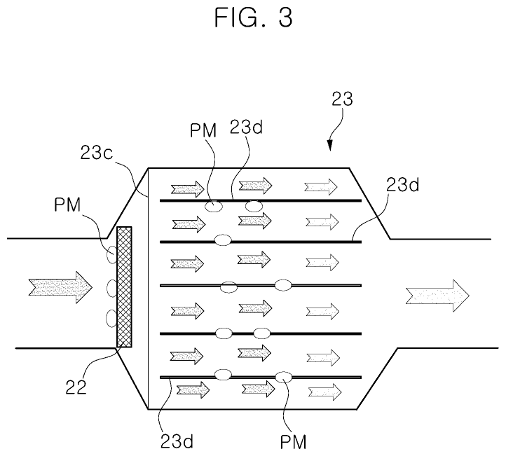

Referring to FIG. 3, the dust collection unit 23 may include: an ionization line 23c for generating a high voltage when power is applied to charge pollutants contained in the air flowing into the dust collection unit 23, and an electrode plate 23d charged when power is applied. Since the pollutants become charged while passing through the ionization line 23c, they are adsorbed onto the electrode plate 23d while passing through the electrode plate 23d, and thus the air passing through the electrode plate 23d may be purified.

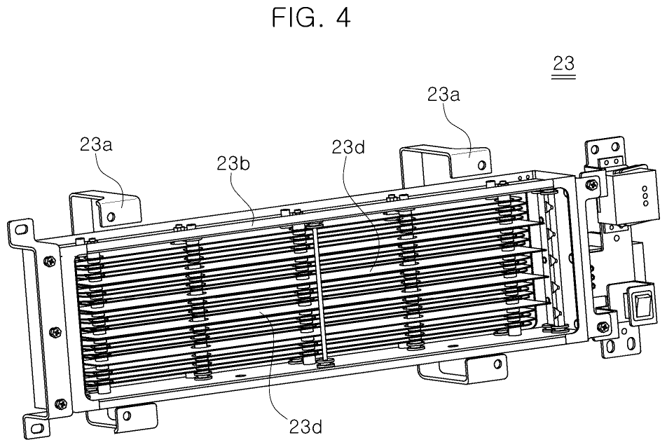

FIG. 4 shows an example of the dust collection unit 23, and the dust collection unit 23 may be mounted inside the duct 21 using a bracket 23a. In the dust collection unit 23, the electrode plates 23d may be disposed parallel to each other inside the frame 23b. When power is applied to the electrode plates 23d, the electrode plates 23d may be charged to a positive (+) electrode and a negative (−) electrode to adsorb pollutants passing therethrough in a charged state.

The dust collection unit 23 may be provided with a power supply unit 23e for applying power to the ionization line 23c and the electrode plates 23d.

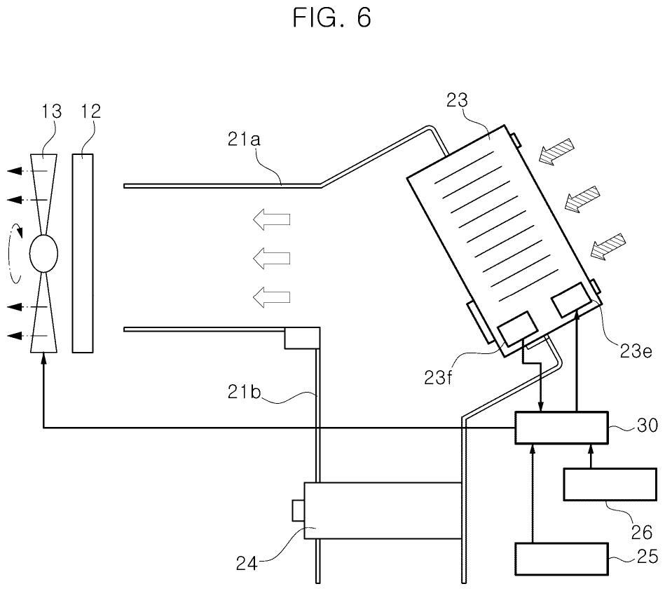

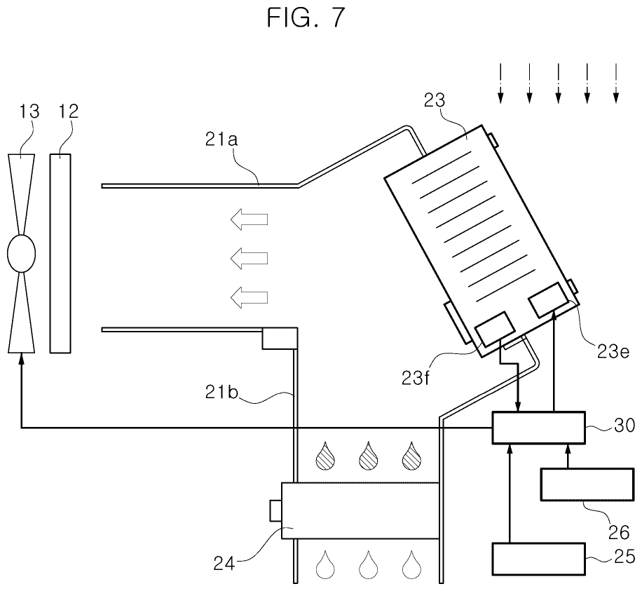

In addition, as illustrated in FIGS. 6-7, the dust collection unit 23 may include a resistance sensor 23f. The resistance sensor 23f may measure and output an insulation resistance of the dust collection unit 23. The reason for detecting the insulation resistance of the dust collection unit 23 may be to determine whether it is raining using the insulation resistance of the dust collection unit 23, which can be damaged or destroyed when humidity is very high, for example, during rain.

A rain sensor 25 for directly sensing the rain may be installed in the vehicle. When the rain sensor 25 installed on a windshield and the like of the vehicle 1 detects raindrops, the rain sensor 25 may output a raindrop detection signal.

In one embodiment, a water filter 24 may be installed on the water duct 21b. The water filter 24 may filter pollutants contained in moisture drained through the water filter 24. In a rainy state, moisture may be introduced through the inlet 11, and as the moisture passes through the dust collection unit 23, the moisture may flow into the water duct 21b together with pollutants adsorbed on the electrode plate 23d. In addition, the dust collection unit 23 may be cleaned by spraying moisture into the dust collection unit 23, and the washing water sprayed for cleaning also flows into the water duct 21b together with the pollutants adsorbed on the electrode plate 23d.

The water filter 24 may filter the pollutants containing moisture drained through the water duct 21b. When the water filter 24 becomes contaminated beyond a predetermined level, it can be replaced and used.

In another embodiment, a pre-filter 22 for collecting pollutants contained in the air flowing into the duct 21 may be installed in front of the dust collection unit 23 in the duct 21. The pre-filter 22 may primarily collect and purify the pollutants flowing into the duct 21. The pollutants being collected by the pre-filter 22 may be pollutants with relatively large particle sizes, and the pollutants not being collected by the pre-filter 22 may be adsorbed on the electrode plate 23d to purify the air.

A dust concentration sensor 26 may be installed at one side outside the vehicle 1 to measure and output the dust concentration of the outside air. The dust concentration of the outside air measured through the dust concentration sensor 26 may be compared with a reference concentration to determine whether the dust collection unit 23 operates.

A control unit 30 may control the operation of the dust collection unit 23 and the cooling fan 13. The control unit 30 may receive a vehicle speed from the vehicle 1, the dust concentration of the outside air from the dust concentration sensor 26, a raindrop detection signal from the rain sensor 25, and the insulation resistance value of the dust collection unit 23 from the sensor 23f. Since a method of controlling the outside air purification system for a vehicle to be described below is stored as logic (e.g., a set of programed instructions or algorithms) in the control unit 30, the control unit 30 may control the operation of the dust collection unit 23 and the cooling fan 13. When the dust concentration of the outside air is greater than or equal to a reference concentration, the control unit 30 may operate the dust collection unit 23 to purify the outside air. For example, when the vehicle 1 stops or travels slowly, the control unit 30 may operate the cooling fan 13 to forcibly allow outside air to flow into the dust collection unit 23. In addition, the control unit 30 may operate the dust collection unit 23 when it is determined that it is not raining, based on data or signals from the resistance sensor 23f and the rain sensor 25. When it is determined that it is raining, the control unit 30 may not operate the dust collection unit 23.

A method of controlling the outside air purification system for a vehicle according to the present disclosure is described as follows.

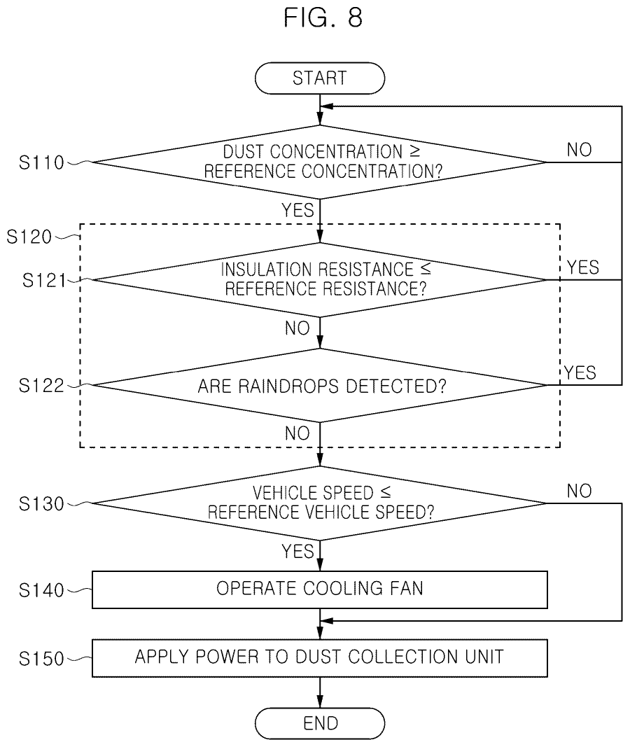

As shown in FIG. 8, the method of controlling the outside air purification system for a vehicle according to the present disclosure includes a dust concentration comparing operation (an operation S110) of allowing the control unit 30 to determine whether a dust concentration of outside air is greater than or equal to a preset reference concentration to operate the dust collection unit 23, and a dust collection unit operating operation (operation S150) of allowing the control unit 30 to apply power to the dust collection unit 23 so that the dust collection unit 23 operates.

In the dust concentration comparing operation (the operation S110), the dust concentration of the outside air of the vehicle 1 may be determined whether it is greater than the reference concentration.

The control unit 30 may receive the dust concentration of the outside air from the dust concentration sensor 26 and compare the measured dust concentration of the outside air with the reference concentration. The reference concentration may be a dust concentration previously set to operate the dust collection unit 23 and stored in the control unit 30. When the dust concentration of the outside air is greater than or equal to the reference concentration, purification of the outside air may be needed, and thus the control unit 30 may determine whether to operate the dust collection unit 23 by comparing the dust concentration with the reference concentration.

The control unit 30 may perform each operation to be described below when the dust concentration is greater than or equal to the reference concentration, and when the dust concentration is smaller than the reference concentration, allows the dust concentration comparing operation (the operation S110) to be repeatedly performed.

A rain determining operation (an operation S120) may determine whether it is currently raining, i.e., currently rainy weather condition.

Since dust may not be adsorbed through the dust collection unit 23 during rain, the control unit 30 may determine whether it is current raining.

To determine whether it is raining, the control unit 30 may perform an insulation resistance comparing operation (an operation S121) and a raindrop detection determining operation (an operation S122).

The insulation resistance comparing operation (the operation S121) may determine whether the insulation resistance inside the dust collection unit 23 is smaller than a reference resistance preset to operate the dust collection unit 23 and stored in the control unit 30. When a large amount of moisture flows into the dust collection unit 23 due to rain or the like, the insulation resistance inside the dust collection unit 23 may be damaged or destroyed.

Therefore, the control unit 30 may determine that it is raining when the insulation resistance is smaller than the reference resistance. When the insulation resistance is smaller than the reference resistance in the insulation resistance comparing operation (in the operation S121), the process may return to the dust concentration comparing operation (the operation S110) so that the dust concentration comparing operation is re-performed.

In the raindrop detection determining operation (the operation S122), the control unit 30 may determine whether a raindrop detection signal is input from the rain sensor 25 to the control unit 30. Since the raindrop detection signal is input from the rain sensor 25 to the control unit 30 during rain, when the rain sensor 25 may detect raindrops, the control unit 30 may determine that it is raining.

When the rain sensor 25 detect raindrops in the raindrop detection determining operation (the operation S122), the process may return to the dust concentration determining operation (the operation S110).

Meanwhile, whether it is raining may be determined by performing only any one of the insulation resistance comparing operation (the operation S121) and the raindrop detection determining operation (the operation S122). However, to accurately determine whether it is raining, both the insulation resistance comparing operation (the operation S121) and the raindrop detection determining operation (the operation S122) may be performed.

In addition, since the subsequent operations may be performed only when it is determined that it is not raining in both the insulation resistance comparing operation (S121) and the raindrop detection determining operation (S122), the raindrop detection determining operation (S122) may be performed first, and then, the insulation resistance comparing operation (S121) may be performed.

In a vehicle speed comparing operation (an operation S130), the vehicle speed may be compared with a reference speed previously set to operate the cooling fan 13 and stored in the control unit 30. When the vehicle 1 travels, the sufficient amount of air may flow into the dust collection unit 23, and thus the air may be purified by the dust collection unit 23, but when the vehicle 1 stops or travels slowly, the sufficient amount of air may not flow into the dust collection unit 23, and thus the certain amount of air should forcibly flow into the dust collection unit 23.

Therefore, the control unit 30 may compare the vehicle speed of the vehicle 1 with the reference vehicle speed in the vehicle speed comparing operation (S130). When the vehicle speed is smaller than or equal to the reference vehicle speed, a cooling fan operating operation (an operation S140) may be performed, and when the vehicle speed exceeds the reference vehicle speed, the cooling fan operating operation (S140) may not be performed.

Here, the reference speed may be set to 10 kph. In other words, when the vehicle speed of the vehicle 1 is 10 kph or less, the cooling fan operating operation (S140) may be performed, and when the vehicle speed of the vehicle 1 exceeds 10 kph, the sufficient amount of air may flow into the dust collection unit 23, and thus the cooling fan operating operation (S140) may not be performed.

In the cooling fan operating operation (S140), when the vehicle speed is smaller than or equal to the reference speed, the control unit 30 may operate the cooling fan 13. The control unit 30 may operate the cooling fan 13 installed to cool the battery to allow the sufficient amount of air to flow into the dust collection unit 23.

In the dust collection unit operating operation (the operation S150), the control unit 30 may apply power to the dust collection unit 23 so that the dust collection unit 23 operates.

The dust collection unit operating operation (S150) may be performed when the vehicle speed exceeds the reference vehicle speed in the vehicle speed comparing operation (S130) or after the cooling fan operating operation (S140).

When power is applied to the dust collection unit 23, a high voltage may be generated from the ionization line 23c of the dust collection unit 23, and thus the pollutants passing through the ionization line 23c may pass through the electrode plate 23d in the charged state. Since the electrode plate 23d is in a charged state in the state in which power is applied to the dust collection unit 23, the pollutants such as PM, may be adsorbed to the electrode plate 23d.

FIGS. 5 to 7 show an operation state of the dust collection unit 23.

FIG. 5 shows a state in which the vehicle 1 travels. When the vehicle 1 travels and when a predetermined amount of air may flow into the dust collection unit 23 due to traveling wind, the air may pass through the dust collection unit 23 by the traveling wind, so the control unit 30 may be configured not to operate the cooling fan 13. Therefore, when only power is applied to the dust collection unit 23 by the control unit 30, the air may be purified in the dust collection unit 23.

FIG. 6 shows a state in which the vehicle 1 stops or travels slowly. When the vehicle 1 stops or travels slowly, the traveling wind may not present or may be insignificant, and thus the control unit 30 may additionally operate the cooling fan 13 to allow the sufficient amount of air to flow into the dust collection unit 23. At the same time, when power is applied to the dust collection unit 23, pollutants may be adsorbed and purified in the dust collection unit 23.

As described above, since the vehicle purifies the air while traveling or stopping on the road, pollutants in the air may be reduced.

FIG. 7 shows a state during raining. When it is raining, moisture may flow into the dust collection unit 23 through the duct 21. As the moisture passes through the electrode plate 23d, the moisture may be drained into the water duct 21b together with the pollutants adsorbed on the electrode plate 23d. When the moisture passes through the water duct 21b, the moisture may be filtered by the water filter 24. When the water filter 24 is contaminated to a predetermined level or more, the water filter 24 may be replaced.

What is claimed is:

1. An outside air purification system for a vehicle, comprising:
a cooling fan installed on a roof of the vehicle;
a duct configured to guide air to the cooling fan; and
a dust collection unit installed inside the duct and configured to adsorb pollutants contained in the air flowing through the duct.

2. The outside air purification system of claim 1, wherein the dust collection unit includes:
an ionization line installed at an inlet of the dust collection unit and configured to generate a high voltage when power is applied to the dust collection unit; and
a plurality of electrode plates installed behind the ionization line and disposed parallel to each other, wherein the plurality of electrode plates is configured to be charged when the power is applied to the dust collection unit.

3. The outside air purification system of claim 2, wherein the pollutants contained in the air flowing into the dust collection unit are charged while passing through the ionization line and adsorbed to the plurality of electrode plates while passing through the plurality of electrode plates.

4. The outside air purification system of claim 1, further comprising a pre-filter configured to collect the pollutants contained in the air flowing into the duct which is installed in front of the dust collection unit in the duct.

5. The outside air purification system of claim 1, wherein the duct includes:
an air duct configured to guide the air from an inlet installed on the roof to the duct; and
a water duct branched from the air duct to drain moisture flowing into the inlet.

6. The outside air purification system of claim 5, wherein a water filter configured to filter the pollutants contained in the moisture passing through the dust collection unit is installed on the water duct.

7. The outside air purification system of claim 1, further comprising a control unit configured to receive a dust concentration from a dust concentration sensor installed on the vehicle and control an operation of the dust collection unit and the cooling fan.

8. The outside air purification system of claim 7, wherein the control unit is configured to operate the cooling fan when a vehicle speed of the vehicle is less than or equal to a reference vehicle speed previously set to operate the cooling fan.

9. The outside air purification system of claim 7, further comprising:
a rain sensor configured to detect raindrops outside the vehicle; and
a resistance sensor configured to detect an insulation resistance of the dust collection unit inside the dust collection unit,
wherein output values of the rain sensor and the resistance sensor are input to the control unit.

10. The outside air purification system of claim 9, wherein the control unit is configured to determine that it is raining when raindrops are detected by the rain sensor or when the insulation resistance inside the dust collection unit measured by the resistance sensor is smaller than or equal to a preset reference resistance to stop the operation of the dust collection unit.

11. The outside air purification system of claim 1, wherein the cooling fan is configured to cool a battery installed on the roof.

12. A method of controlling an outside air purification system for a vehicle, the method comprising:
a dust concentration comparing operation in which a control unit determines whether a dust concentration of outside air is greater than or equal to a reference concentration previously set to operate a dust collection unit; and
a dust collection unit operation in which the control unit applies power to the dust collection unit so that the dust collection unit operates.

13. The method of claim 12, further comprising:
a vehicle speed comparing operation in which, before the dust collection unit operation is performed, the control unit compares a vehicle speed of the vehicle with a reference speed previously set to operate a cooling fan; and
a cooling fan operation in which the control unit operates the cooling fan mounted for cooling a battery when the vehicle speed is less than or equal to the reference speed.

14. The method of claim 13, wherein, in response to that the vehicle speed exceeds the reference speed in the vehicle speed comparing operation, the dust collection unit operation is performed.

15. The method of claim 13, further comprising a rain determining operation in which the control unit determines whether it is raining between the dust concentration comparing operation and the vehicle speed comparing operation,
wherein in response to that it is not raining, the vehicle speed comparing operation is performed.

16. The method of claim 15, wherein the rain determining operation includes:
an insulation resistance comparing operation in which the control unit compares an insulation resistance inside the dust collection unit with a reference resistance previously set to operate the dust collection unit; and
a raindrop detection determining operation in which the control unit determines whether a raindrop detection signal is input to the control unit from a rain sensor.

17. The method of claim 16, wherein the control unit determines that it is raining when the insulation resistance is smaller than or equal to the reference resistance or the raindrop detection signal is input from the rain sensor.

18. The method of claim 15, wherein, in response to that it is raining in the rain determining operation, reperforming the dust concentration comparing operation.

19. The method of claim 13, wherein in response to determination that the vehicle travels and a predetermined amount of air flows into the dust collection unit due to traveling wind, the control unit does not operate the cooling fan.

20. The outside air purification system of claim 1, further comprising dissipating heat while coolant cooling a battery circulates in the outside air purification system by a heat exchanger in front of the cooling fan.
